(19) United States
(12) Patent Application Publication
(10) Pub. No.: US 2017/0115149 A1
(43) Pub. Date: Apr. 27, 2017

(54) REMOVABLE HIGH FLOW IMPEDANCE MODULE IN FLOW SENSOR BYPASS CIRCUIT

(71) Applicant: MEMSIC, Inc., Andover, MA (US)

(72) Inventors: Ohlan Silpachai, Newbury Park, CA (US); Nan Jou Pern, Andover, MA (US)

(21) Appl. No.: 15/334,697

(22) Filed: Oct. 26, 2016

Related U.S. Application Data
(60) Provisional application No. 62/246,818, filed on Oct. 27, 2015.

(51) Int. Cl. G01F 5/00; G01F 1/684

(52) U.S. Cl. CPC G01F 5/00; G01F 1/6845; G01F 1/6842

(57) ABSTRACT

A flow element for detecting flow is described. The flow element includes a flow body defining a main flow path having a main flow resistance and a removable flow module defining at least a part of a bypass flow path having a bypass flow resistance. The bypass flow resistance being much greater than the main flow resistance, such as being a thousand times greater than the main flow resistance. The flow body further defines a bypass flow inlet and a bypass flow outlet. The bypass flow inlet and the bypass flow outlet fluidly connect the bypass flow path to the main flow path.

### STATEMENT REGARDING FEDERALLY SPONSORED RESEARCH OR DEVELOPMENT

N/A

### BACKGROUND OF THE INVENTION

Various embodiments relate generally to fluid flow sensor systems and devices, more specifically, relate to a removable, high flow impedance, fluid flow sensor.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Micro-Electro-Mechanical Systems (MEMS) based thermal sensors are known in many different configurations. A basic MEMS flow sensor includes a heater and at least one temperature sensor in the near vicinity to detect heat fluctuation as fluid moves over the heater and temperature sensor(s). The rate of fluid movement over the heater and temperature sensor(s) can be used to determine flow rate. See further: Zhao et al. U.S. patent Publication Ser. No. ______, U.S. patent application Ser. No. 14/816,628, filed Aug. 3, 2015, the disclosure of which is incorporated by reference herein in its entirety.

MEMS thermal flow sensors can be miniaturized, can use low power consumption and can have excellent sensitivity. They are typically a few square millimeters in size often less than one millimeter thick. Since MEMS thermal flow sensors are minute by nature and can measure very low flow gas flow rates, a bypass setup can be used for higher flow measurement. In this setup, a thermal MEMS flow sensor is used to measure less than a few milliliters per minute of flow while the main flow channel experiences up to 100 liters per minute and beyond. Although the sensor measures less than 1/100th of the overall flow, the setup is highly accurate and can achieve 1%-3% of reading accuracy.

In flow measurement applications where there are contaminants in the fluid, cleaning is performed on a periodic basis. The MEMS bypass sensor is sometimes removed when cleaning. To facilitate removal of the sensor, the sensor is prepackaged with its own flow channel to prevent damages to the fragile chip. With the MEMS sensor removed, cleaning the main passage is feasible without fear of subjecting electronics to harsh cleaning procedures such as autoclave or gamma radiation where components are highly heated and pressurized or bombarded with high level of radiation.

Most MEMS sensors on the market today utilize air flow of 100 milliliters per minute and above when used in a bypass setup. This flow range makes re-installation problematic since the process introduces minor changes to the bypass flow thus impacting the relationship between bypass and main passage flow. This change in turn impacts the calibration of the sensor making the use of a removable sensor module impractical.

What is needed is a bypass flow module that utilizes much less fluid flow by increasing the flow impedance of the sensor module.

### BRIEF SUMMARY OF THE INVENTION

The below summary is merely representative and non-limiting.

The above problems are overcome, and other advantages may be realized, by the use of the embodiments.

In a first aspect, an embodiment provides a flow element for detecting flow. The flow element includes a flow body defining a main flow path having a main flow resistance and a removable flow module defining at least a part of a bypass flow path having a bypass flow resistance. The bypass flow resistance being much greater than the main flow resistance. The flow body further defines a bypass flow inlet and a bypass flow outlet. The bypass flow inlet and the bypass flow outlet fluidly connect the bypass flow path to the main flow path.

### BRIEF DESCRIPTION OF THE SEVERAL VIEWS OF THE DRAWINGS

Aspects of the described embodiments are more evident in the following description, when read in conjunction with the attached Figures.

FIG. 1 shows a simplified block diagram of a traditional MEMS device.

FIG. 2 illustrates the electrical equivalent of the flow setup shown in FIG. 1.

FIG. 3 shows a device that is suitable for practicing various embodiments.

FIG. 4 shows another device that is suitable for practicing various embodiments.

FIG. 5 shows a simplified diagram of a removable bypass module that is suitable for practicing various embodiments.

FIG. 6 shows a simplified device having the flow sensor module of FIG. 5.

### DETAILED DESCRIPTION OF THE INVENTION

This patent application claims priority from U.S. Provisional Patent Application No. 62/246,818, filed Oct. 27, 2015, the disclosure of which is incorporated by reference herein in its entirety.

A traditional MEMS flow sensor module can be used in a bypass setup with a larger (main pass) flow body. In this setup, a pressure drop element in the main pass forces a fraction of the air to travel to the bypass MEMS flow sensor. When calibrated, the flow measurement is highly repeatable, typically better than one percent. However, if disturbed, whereby the thermal MEMS flow sensor module is removed and reinstalled, repeatability can be impacted as reinstallation changes the flow characteristics of the bypass. During reinstallation, any differences in the mechanical alignment change the flow path resistance thereby changing the fluid flow to the MEMS bypass sensor.

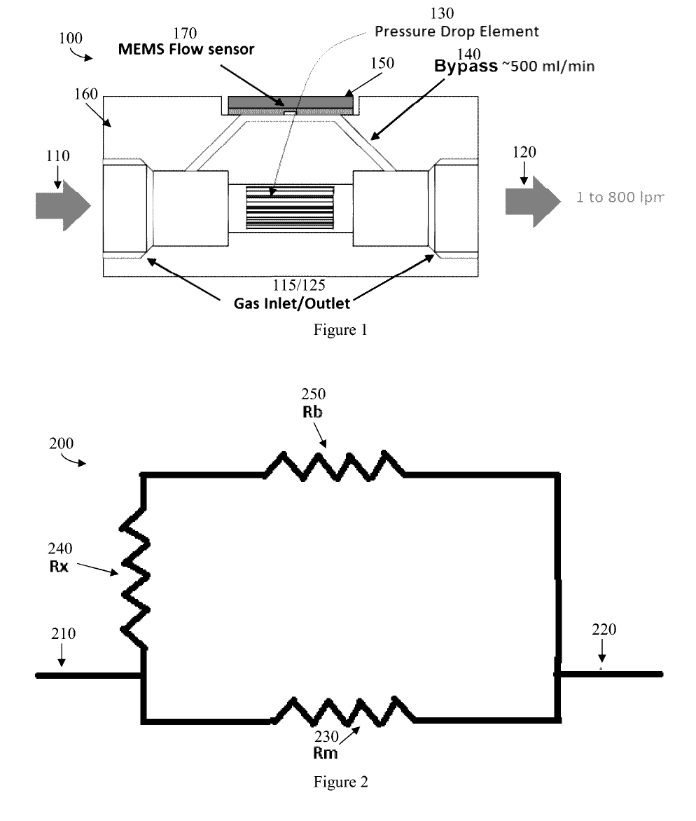

FIG. 1 shows a simplified block diagram of a traditional flow element 100. A standard flow sensor module 150 uses a MEMS thermal flow sensor 170 in a bypass setup. The input flow 110 is received at the gas input 115. The pressure drop element 130 creates a resistance to the flow in the main body 160 and a small amount of flow is forced into the bypass 140. Once the bypass flow travels past the sensor module 150 through the bypass 140 it merges back with the flow in the main body 160 and the resulting output flow 120 leaves the device 100 through the gas outlet 125. In one, non-limiting embodiment, the flow may be 1 to 800 liters per minute. FIG. 2 illustrates the electrical equivalent of the flow setup shown in FIG. 1. In this flow setup, the input flow 210 experiences resistances from the various components in the flow elements before leaving as an output flow 220. Rm 230 is the resistance generated by the pressure drop element, Rb 250 is the resistance of the bypass flow channel and Rx 240 is the interface resistance between the main housing and the sensor module.

For a lower impedance thermal MEMS sensor available which consumes about 100 ml/min or above, the change in Rx impedance from removing and installing the sensor module could be significant in comparison to the total summation of both resistors in series. However, if the impedance of the sensor itself is reduced by 98% so the flow through the sensor is restricted to only a few ml/min of fluid flow, the change in impedance from the reinstallation of the sensor module would result in much lower overall air flow through the reinstalled sensor.

In various embodiments, a high impedance thermal MEMS flow sensor is used as a bypass setup to facilitate re-installation without significantly altering the flow sensor calibration or performance for applications requiring removal of the sensor module for cleaning of the main flow body.

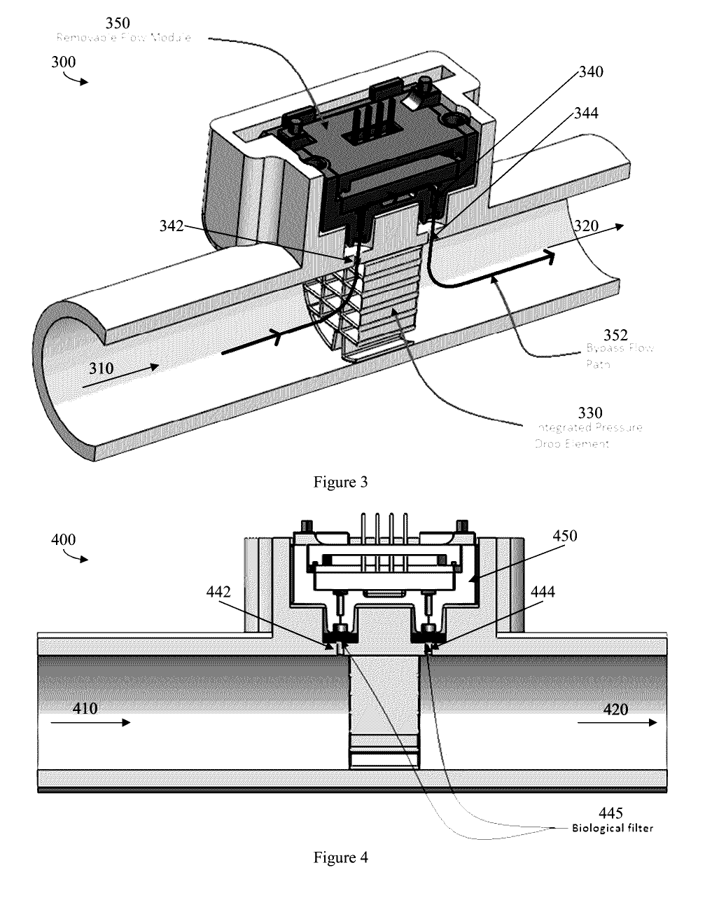

FIG. 3 shows a flow element 300 that is suitable for practicing various embodiments. The flow element 300 can be placed along a flow path such that an input flow 310 enters the flow element 300. The integrated pressure drop element 330 forces a small part of that flow into the bypass flow path 352 through a flow channel inlet 342. The bypass flow path 352 travels through a flow channel 340 of a removable flow module 350 where it may be measured. The bypass flow path 352 leaves through a flow channel outlet 344 and merges back with the main flow before leaving the flow element 300 as part of the output flow 320.

FIG. 4 shows another flow element 400 that is suitable for practicing various embodiments. Similar to flow element 300 of FIG. 3, the flow element 400 diverts a portion of the input flow 410 to be measured before being merged into the output flow 420. This bypass flow travels through a biological filter 445 located between the flow channel inlet 442 and the removable flow module 450. Another biological filter 445 is located between the removable flow module 450 and the flow channel outlet 444.

In various embodiments, a high impedance thermal MEMS flow sensor is used in a flow element such that the resistance of the bypass flow path is significantly higher than the resistance in the main flow path. The MEMS flow sensor may thus be removed when cleaning the flow element or for replacement without necessitating re-calibration as any changes in the flow (for example, due to misalignment, etc.) do not produce a sufficient change in the overall resistance of the bypass flow path.

As an example, Table 1 illustrates the impact when the sensor module is reinstalled if the main pass to bypass ratio is 1000:1. If the resistance of installation is 20% of the sensor module resistance, a reinstallation change of 100% results in approximately 10% error when calculating the combined resistance divided by the original sensor resistance. Alternatively, as shown in Table 2, when using high impedance thermal MEMS flow sensor, the impedance is 100 times lower resulting in a main pass to bypass ratio of 10,000:1 and the same reinstallation error is reduced now to only 1% since the change in reinstallation does not significantly impact the high impedance sensor.

TABLE 1
Low Impedance Flow Sensor simulation
Low Impedance Sensor

| | Original | Reinstalled | Delta (% of Rb) |
|---|---|---|---|
| Rm | 100 | 100 | 0.00% |
| Rb | 100,000 | 100,000 | 0.00% |
| Rx | 20,000 | 10,000 | −10.00% |
| Rb + Rx | 120,000 | 110,000 | −10.00% |
| RT | 100 | 100 | 0.00% |

TABLE 2
High Impedance Flow Sensor simulation
High Impedance Sensor

| | Original | Reinstalled | Delta (% of Rb) |
|---|---|---|---|
| Rm | 100 | 100 | 0.00% |
| Rb | 1,000,000 | 1,000,000 | 0.00% |
| Rx | 20,000 | 10,000 | −1.00% |
| Rb + Rx | 1,020,000 | 1,010,000 | −1.00% |
| RT | 100 | 100 | 0.00% |

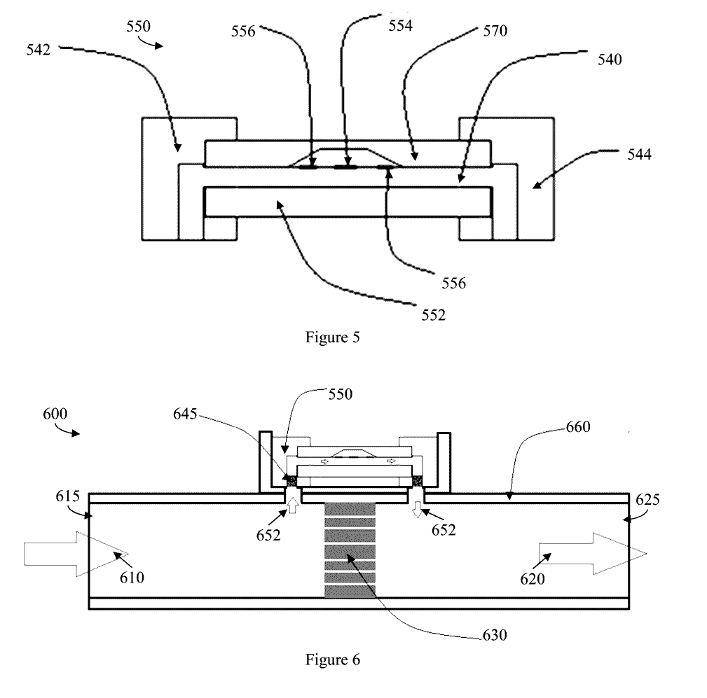

FIG. 5 shows a simplified diagram of a removable bypass module 550 and FIG. 6 shows a flow element 600 having the removable bypass module 550 of FIG. 5. The removable bypass module 550 can be prepackaged to facilitate removing and installation such that the main flow body 660 can be cleaned or sterilized to eliminate contamination or buildup of microorganisms.

In this non-limiting embodiment, the bypass flow module 550 is installed into the flow body 660 of the flow element 600. The flow element 600 has a pressure drop element 630 used to generate a pressure difference such that some air/fluid flow is forced through the bypass flow module 550. The bypass flow module 550 comprised a MEMS thermal flow sensor 570, which has an integrated heater 554 and temperature sensors 556 to measure flow, is capped with a glass or silicon substrate 552. The bypass flow module 550 includes an etched flow channel 540 such that the flow impedance through the sensor is very high. The bypass flow module 550 also includes flow channel inlet/outlet 542/544 to allow ease of installation into the main flow body 660.

The heater 554 of the bypass flow module 550 is in near proximity of at least one temperature sensor 556. As flow increases, the amount of heat convects to the heater 554 increases or decreases depending on the positioning of the heater 554 to the temperature sensor 556 with respect to flow. Thus, the bypass flow module 550 can be used to measure the flow passing through the etched flow channel 540 and the flow through the flow element 600 determined.

In an alternative embodiment, the heater 554 and temperature sensors 556 can be etched on each wall outside of the flow channel but not connected to each other. The heaters 554 can be energized from a suitable source, and signals from the respective temperature sensors 556 are received by signal processing circuitry (such as a data processor) and processed to provide an indication of flow rate.

When installed in the flow element 600, the bypass flow module 550 receives a portion of the input flow 610 coming into the flow element at the inlet 615. The pressure drop element 630 directs this portion of the flow, the bypass flow 652, through filter 645 before entering the bypass flow module 550 to be measured. After measurement, the bypass flow passes through another filter 645 before merging back into the main flow. The filters 645 protect the sensor from contamination. The resulting output flow 620 leaves the flow element through the outlet 625.

In a further embodiment, the filters 645 may be biological filters.

In other embodiments, the pressure drop element 630 features various structures, such as concentric rings, a honey-comb design, etc. These structures may be integrated into the flow body 660 or attached to the flow body 660. Alternatively, the pressure drop element 630 may be omitted altogether.

In a further embodiment, the bypass flow module 550 may also include additional temperature sensors, a humidity sensor and/or a barometric sensor. A temperature sensor can allow temperature compensation. A humidity sensor along with a temperature sensor can be used to determine possible condensation and/or compensate for mass air flow for exhalation applications. A barometric sensor could be used when the application requires volumetric flow rather than mass air flow.

The inlet to the bypass flow pass can be perpendicular to the main flow path, such as shown in FIGS. 3-6. Alternatively, the inlet may be angled similar to that shown in FIG. 1. Such an angled path may result in less flow disruption.

In another embodiment, the flow element may include a film heater integrated into the flow body 660 to heat fluid flowing through the main flow channel.

An embodiment provides a flow sensor for detecting flow. The flow sensor has a high impedance removable bypass module that can be installed and removed from a main flow body allowing cleaning and sterilizing of the main flow body without damaging the flow sensor.

A further embodiment provides a flow sensor for detecting flow. The flow sensor includes a removable high impedance bypass module that can be removed and reinstalled without adverse effects to performance.

Another embodiment provides a flow sensor for detecting flow. The flow sensor includes an interchangeable high impedance bypass module and a main flow body where the bypass flow module can be replaced or interchanged without recalibration of the flow sensor.

A further embodiment provides a flow element for detecting flow. The flow element includes a flow body defining a main flow path having a main flow resistance and a removable flow module defining at least a part of a bypass flow path having a bypass flow resistance. The bypass flow resistance being much greater than the main flow resistance. The flow body further defines a bypass flow inlet and a bypass flow outlet. The bypass flow inlet and the bypass flow outlet fluidly connect the bypass flow path to the main flow path.

In another embodiment of the flow element above, the bypass flow resistance is greater than one thousand (1,000) times the main flow resistance.

In a further embodiment of the flow element above, the removable flow module includes a module body having a substrate; a flow channel in the substrate and having a flow channel inlet opening and a flow channel outlet opening; a heater configured to heat fluid flowing through the flow channel; and one or more film temperature sensors configured to sense temperature of fluid flowing through the flow channel.

In another embodiment of the flow element above, the substrate is a semiconductor substrate and/or a glass substrate.

In a further embodiment of the flow element above, the flow element includes a pressure drop element configured to force a portion of the fluid flowing through the main flow path into the bypass flow path. The pressure drop element may be integrated into the flow body.

In another embodiment of the flow element above, the flow element includes one or more filters disposed between the main flow path and the part of the bypass flow path defined by the removable flow module. The one or more filters may include one or more biological filters.

In a further embodiment of the flow element above, the main flow path is a straight path between a flow element inlet and a flow element outlet.

In another embodiment of the flow element above, the bypass flow path is parallel to the main flow path.

In a further embodiment of the flow element above, the bypass flow inlet defines an inlet interface path having an interface resistance. The bypass flow resistance may be greater than fifty (50) times the interface resistance. The inlet interface path may be perpendicular to the main flow path. Alternatively, the inlet interface path may extend from the main flow path at an angle.

In another embodiment of the flow element above, the flow element includes a humidity sensor and/or a barometric sensor.

In a further embodiment of the flow element above, the flow channel is formed in the substrate using one of: etching, machining and molding.

The foregoing description has been directed to particular embodiments. However, other variations and modifications may be made to the described embodiments, with the attainment of some or all of their advantages. Modifications to the above-described systems and apparatus may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A flow element comprising:
a flow body defining a main flow path having a main flow resistance; and
a removable flow module defining at least a part of a bypass flow path having a bypass flow resistance, the bypass flow resistance being much greater than the main flow resistance,
wherein the flow body further defines a bypass flow inlet and a bypass flow outlet, the bypass flow inlet and the bypass flow outlet fluidly connecting the bypass flow path to the main flow path.

2. The flow element of claim 1, wherein the bypass flow resistance is greater than one thousand times the main flow resistance.

3. The flow element of claim 1, wherein the removable flow module comprises:
a module body having a substrate;
a flow channel etched in the substrate and having an etched inlet opening and an etched outlet opening;
a heater configured to heat fluid flowing through the flow channel; and
at least one film temperature sensor configured to sense temperature of fluid flowing through the flow channel.

4. The flow element of claim 1, wherein the substrate is at least one of: semiconductor and glass.

5. The flow element of claim 1, further comprising a pressure drop element configured to force a portion of the fluid flowing through the main flow path into the bypass flow path.

6. The flow element of claim 5, wherein the pressure drop element is integrated into the flow body.

7. The flow element of claim 1, further comprising at least one filter disposed between the main flow path and the part of the bypass flow path defined by the removable flow module.

8. The flow element of claim 7, wherein the at least one filter comprises at least one biological filter.

9. The flow element of claim 1, wherein the main flow path is a straight path between a flow element inlet and a flow element outlet.

10. The flow element of claim 1, wherein the bypass flow path is parallel to the main flow path.

11. The flow element of claim 1, wherein the bypass flow inlet defines an inlet interface path having an interface resistance.

12. The flow element of claim 11, wherein the bypass flow resistance is greater than fifty times the interface resistance.

13. The flow element of claim 11, wherein the inlet interface path is perpendicular to the main flow path.

14. The flow element of claim 11, wherein the inlet interface path extends from the main flow path at an angle.

15. The flow element of claim 1, further comprising at least one of: a humidity sensor and a barometric sensor.
